(19) United States
(12) Patent Application Publication
(10) Pub. No.: US 2010/0038276 A1
(43) Pub. Date: Feb. 18, 2010

(54) Zipper assembly with a circuit actuating capability and bag having the zipper assembly

(76) Inventor: Jen-Lin Chen, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/459,929

(22) Filed: Jul. 8, 2009

(30) Foreign Application Priority Data
Aug. 13, 2008 (DE) 20 2008 010 762.8

(51) Int. Cl. B65D 79/00; A44B 19/16; H01H 3/02

(52) U.S. Cl. 206/527; 24/399; 200/52 R; 206/314

(57) ABSTRACT

A zipper assembly includes: first and second zipper tapes; a zipper chain having one end and including first teeth secured to the first zipper tape and second teeth secured to the second zipper tape; a zipper slider mounted slidably on the zipper chain for engaging and disengaging the first and second teeth; an end stopper secured to the first and second zipper tapes, and disposed adjacent to the end of the zipper chain; and a switch mounted to the end stopper in such a manner that the switch is switched on by the zipper slider so as to actuate a circuit when the zipper slider is moved to the end of the zipper chain.

### CROSS-REFERENCE TO RELATED APPLICATION

This application claims priority to German Utility Model Application No. DE 20 2008 010 762.8, filed Aug. 13, 2008, the disclosure of which is incorporated herein by reference.

### BACKGROUND OF THE INVENTION

1. Field of the Invention

This invention relates to a zipper assembly with a circuit actuating capability, more particularly to a zipper assembly having a switch that can be switched on by a zipper slider, and to a bag having the zipper assembly.

2. Description of the Related Art

A conventional zipper includes first and second zipper tapes, a zipper chain having first teeth secured to the first tape and second teeth secured to the second tape, and a zipper slider mounted slidably on the zipper chain for engaging and disengaging the first and second teeth.

U.S. Pat. No. 6,712,420 discloses a zipper assembly with integrated electrical contacts. The zipper assembly includes a zipper and conductive points at selected areas of the zipper. The zipper has a zipper chain with first and second teeth that are made of a nonconductive material except at the selected areas where the first and second teeth are made of a conductive material. The zipper assembly establishes an electrical contact or connection with an electrically operable element when the first and second teeth at the selected areas are engaged.

### SUMMARY OF THE INVENTION

An object of the present invention is to provide a zipper assembly with a circuit actuating capability and a bag having the zipper assembly.

According to one aspect of the present invention, there is provided a zipper assembly having a circuit actuating capability and adapted to be coupled to a circuit. The zipper assembly comprises: first and second zipper tapes; a zipper chain having one end and including first teeth secured to the first zipper tape and second teeth secured to the second zipper tape; a zipper slider mounted slidably on the zipper chain for engaging and disengaging the first and second teeth; an end stopper secured to the first and second zipper tapes, separated from the zipper chain, disposed adjacent to the end of the zipper chain, and configured to stop further movement and removal of the zipper slider from the zipper chain; and a switch mounted to the end stopper in such a manner that the switch is switched on by the zipper slider so as to actuate the circuit when the zipper slider is moved to the end of the zipper chain.

According to another aspect of the present invention, there is provided a bag comprising: a bag body; a signal reproduction unit provided on the bag body for producing a signal upon actuation; a power supply circuit coupled electrically to the signal reproduction unit; and a zipper assembly secured to the bag body. The zipper assembly includes: first and second zipper tapes; a zipper chain having one end and including first teeth secured to the first zipper tape and second teeth secured to the second zipper tape; a zipper slider mounted slidably on the zipper chain for engaging and disengaging the first and second teeth; an end stopper secured to the first and second zipper tapes, separated from the zipper chain, disposed adjacent to the end of the zipper chain, and configured to stop further movement and removal of the zipper slider from the zipper chain; and a switch coupled electrically to the power supply circuit and mounted to the end stopper in such a manner that the switch is switched on by the zipper slider so as to actuate the signal reproduction unit through the power supply circuit when the zipper slider is moved to the end of the zipper chain.

### BRIEF DESCRIPTION OF THE DRAWINGS

In drawings which illustrate embodiments of the invention,

FIG. 1A is a perspective view of the first preferred embodiment of a bag having a zipper assembly with a circuit actuating capability according to this invention;

FIG. 1B is an exploded perspective view of an assembly of a switch, a power supply circuit and a signal reproduction unit of the first embodiment;

FIG. 1C is an exploded perspective view of an assembly of an end stopper and the switch of the first embodiment;

FIG. 1D is an assembled perspective view of an assembly of the end stopper and the switch of the first embodiment;

FIG. 2A is a perspective view of the second preferred embodiment of a bag having a zipper assembly with a circuit actuating capability according to this invention;

FIG. 2B is an exploded perspective view of an assembly of a switch and a zipper slider of the second embodiment;

FIG. 3 is a perspective view to illustrate an application of the preferred embodiment to a shopping bag; and

FIG. 4 is a perspective view to illustrate an application of the preferred embodiment to an apron.

### DETAILED DESCRIPTION OF THE PREFERRED EMBODIMENTS

Before the present invention is described in greater detail, it should be noted that same reference numerals have been used to denote like elements throughout the specification.

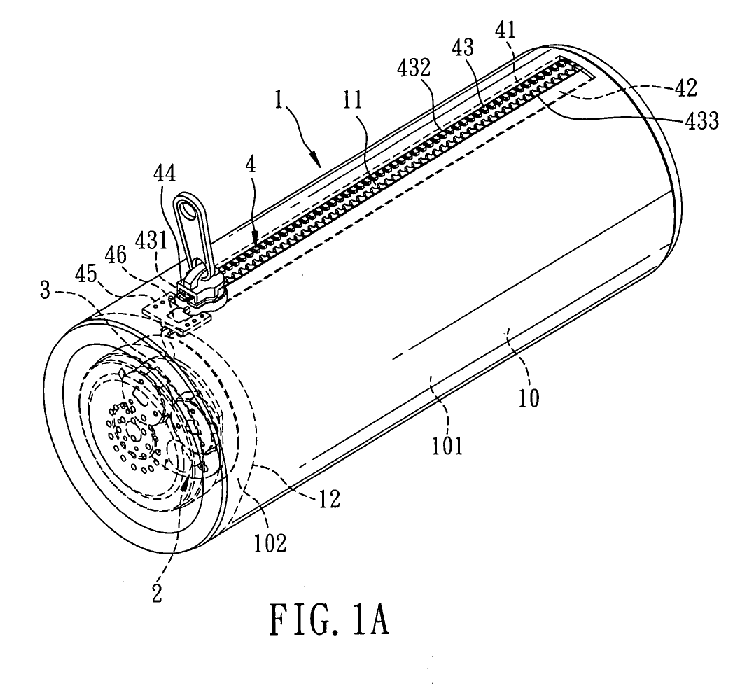

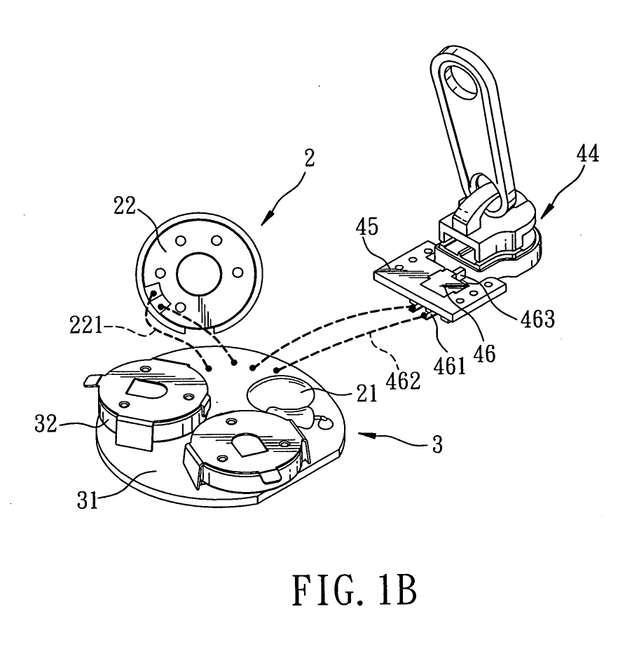

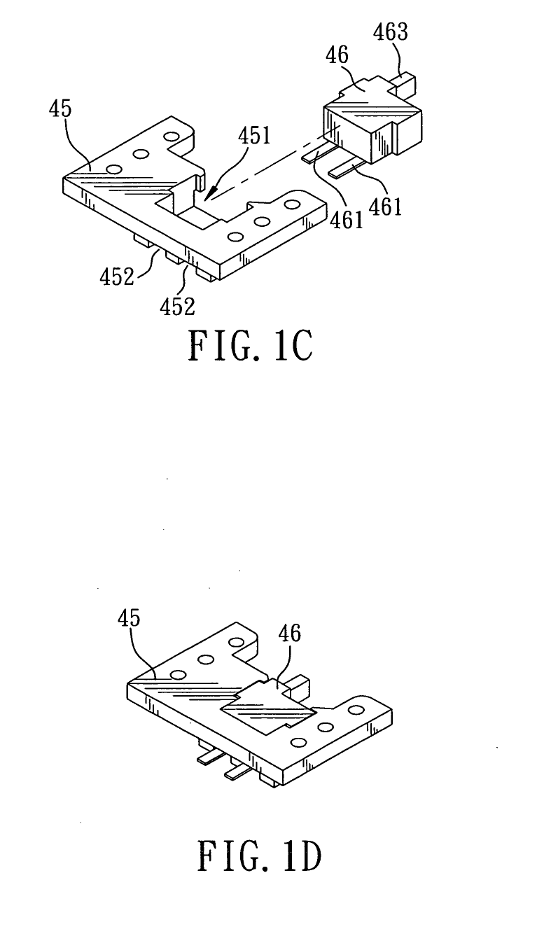

FIGS. 1A to 1D illustrate the first preferred embodiment of a bag having a zipper assembly with a circuit actuating capability according to this invention for receiving articles therein. In this embodiment, the bag is a pen bag. The articles received in the pen bag may be writing utensils, erasers, and the like.

The bag includes: a bag body 1 defining an inner space 10 therein and an access opening 11 for access to the inner space 10; a partitioning member 12 that divides the inner space 10 into a first chamber 101 adapted to receive articles (not shown), and a second chamber 102; a signal reproduction unit 2 mounted in the second chamber 102 for producing a signal upon actuation; a power supply circuit 3 mounted in the second chamber 102 and coupled electrically to the signal reproduction unit 2; and a zipper assembly 4 secured to the bag body 1 and having the capability of actuating the signal reproduction unit 2 through the power supply circuit 3.

The power supply circuit 3 includes a printed circuit board 31, and at least one battery 32 disposed on the printed circuit board 31. The signal reproduction unit 2 includes an audio module 21, such as an MP3 (Motion Picture Experts Group-1 Audio Layer 3) decoder, disposed on the printed circuit board 31, and an electroacoustical transducer 22, such as a speaker, coupled to the printed circuit board 31 through a pair of conductive lines 221.

The zipper assembly 4 includes first and second zipper tapes 41, 42; a zipper chain 43 having one end 431 and including first teeth 432 secured to the first zipper tape 41 and second teeth 433 secured to the second zipper tape 42; a zipper slider 44 mounted slidably on the zipper chain 43 for closing and opening the access opening 11 by engaging and disengaging the first and second teeth 432, 433, respectively; an end stopper 45 secured to the first and second zipper tapes 41, 42, separated form the zipper chain 43, disposed adjacent to the end 431 of the zipper chain 43, and configured to stop further movement and removal of the zipper slider 44 from the zipper chain 43; and a switch 46 coupled electrically to the power supply circuit 3 and mounted to the end stopper 45 in such a manner that the switch 46 is switched on by the zipper slider 44 so as to actuate the signal reproduction unit 2 through the power supply circuit 3 when the zipper slider 44 is moved to the end 431 of the zipper chain 43.

In this embodiment, the end stopper 45 is formed with a recess 451 and two openings 452 that are in spatial communication with the recess 451. The switch 46 is fitted into the recess 451, and includes a pair of conductive leads 461 extending through the openings 452, respectively, and a pair of conductive lines 462 extending between and interconnecting the conductive leads 461 and the printed circuit board 31. The end stopper 45 allows the switch 46 to be stably mounted to the first and second zipper tapes 41, 42. Electrical connection and disconnection between the conductive lines 462 is controlled by the switch 46, and result in activation and deactivation of the signal reproduction unit 2 through the power supply circuit 3, respectively.

In this embodiment, the switch 46 is in the form of a pressable button switch, and further includes a pressable button 463 protruding outwardly of the recess 451. The pressable button 463 is pressed by the zipper slider 44 when the zipper slider 44 is moved to the end 431 of the zipper chain 43, such that the switch 46 is switched on. This, in turn, results in electrical connection between the conductive lines 462, and thus supply of power from the power supply circuit 3 to the signal reproduction unit 2. Ultimately, this results in activation of the electroacoustical transducer 22 through the audio module 21 to thereby generate audio signal(s) for notifying the user that the access opening 11 of the bag body 1 is opened.

In this embodiment, the bag body 1 is cylindrical in shape, and is made of a flexible material, such as textile or leather.

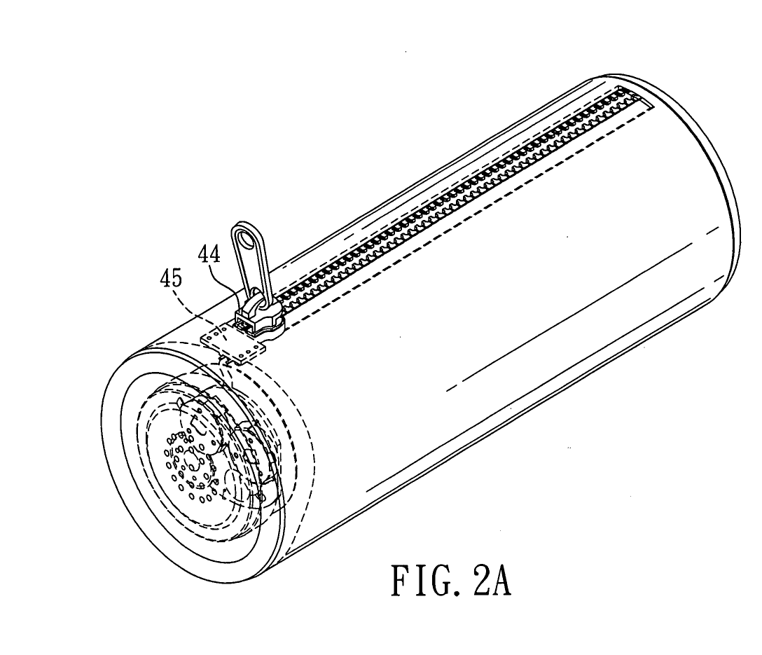

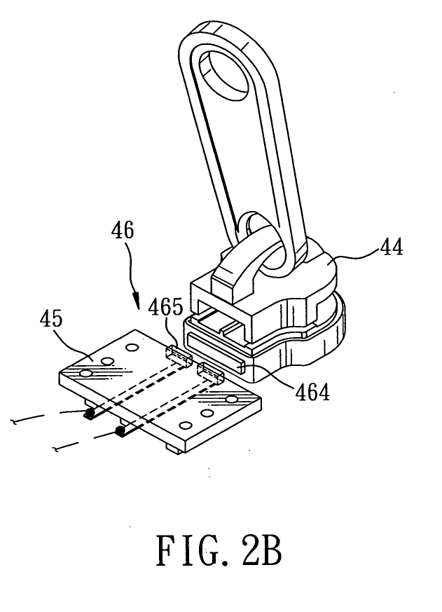

FIGS. 2A and 2B illustrate the second preferred embodiment of a bag having a circuit actuating capability according to this invention. The second preferred embodiment differs from the previous embodiment in that the switch 46 is in the form of a contact switch, and includes a first conductive contact 464 secured to the zipper slider 44, and two second conductive contacts 465 secured to the end stopper 45 and spaced apart from each other. The second conductive contacts 465 are connected to each other through the first conductive contact 464 when the zipper slider 44 is moved to the end 431 of the zipper chain 43.

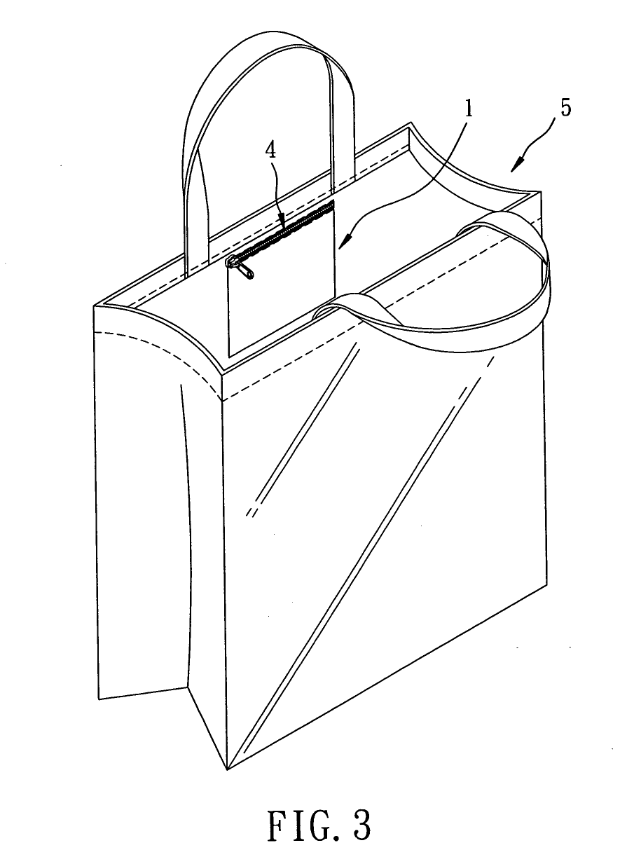

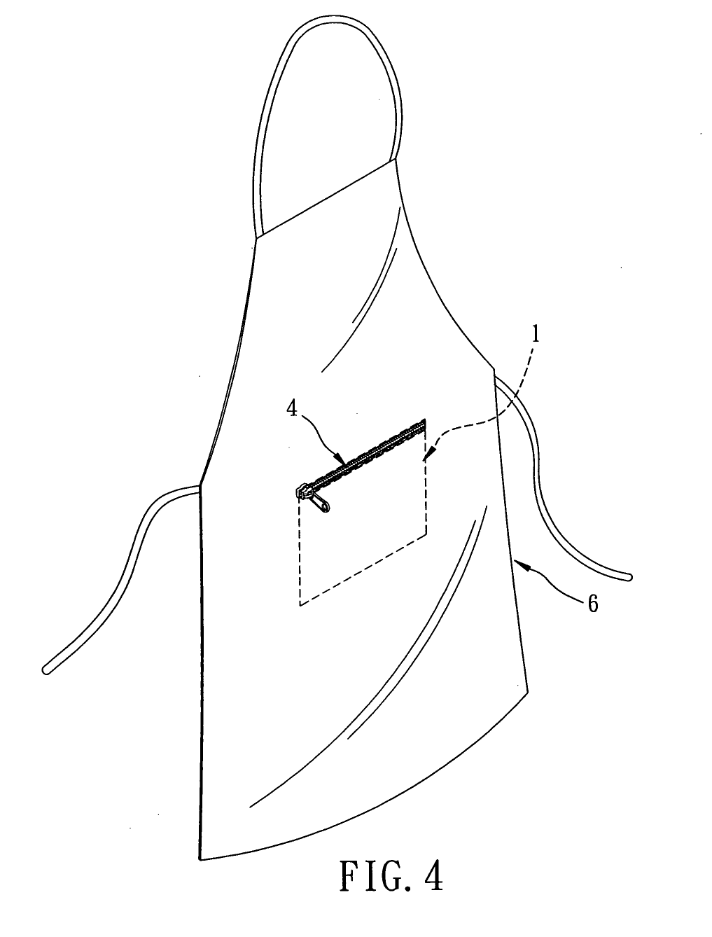

The size and shape of the bag of this invention can be varied depending on the application. FIG. 3 illustrates an application of the preferred embodiment to a shopping bag 5. FIG. 4 illustrates an application of the preferred embodiment to an apron 6.

In conclusion, with the inclusion of the zipper slider 44, the end stopper 45, and the switch 46 of this invention, the zipper assembly 4 can have a circuit actuating capability for actuating a circuit, such as the signal reproduction unit 2.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A zipper assembly having a circuit actuating capability and adapted to be coupled to a circuit, said zipper assembly comprising:
first and second zipper tapes;
a zipper chain having one end and including first teeth secured to said first zipper tape and second teeth secured to said second zipper tape;
a zipper slider mounted slidably on said zipper chain for engaging and disengaging said first and second teeth;
an end stopper secured to said first and second zipper tapes, separated from said zipper chain, disposed adjacent to said end of said zipper chain, and configured to stop further movement and removal of said zipper slider from said zipper chain; and
a switch mounted to said end stopper in such a manner that said switch is switched on by said zipper slider so as to actuate the circuit when said zipper slider is moved to said end of said zipper chain.

2. The zipper assembly of claim 1, wherein said end stopper is formed with a recess, said switch being fitted into said recess.

3. The zipper assembly of claim 2, wherein said end stopper is further formed with two openings that are in spatial communication with said recess, said switch having a pair of conductive leads extending through said openings, respectively.

4. The zipper assembly of claim 2, wherein said switch is in the form of a pressable button switch and includes a pressable button protruding outwardly of said recess, said pressable button being pressed by said zipper slider when said zipper slider is moved to said end of said zipper chain.

5. The zipper assembly of claim 1, wherein said switch is in the form of a contact switch and has a first contact and two second contacts, said first contact being secured to said zipper slider, said second contacts being secured to said end stopper and being spaced apart from each other, said second contacts being connected to each other through said first contact when said zipper slider is moved to said end of said zipper chain.

6. A bag comprising:
a bag body;
a signal reproduction unit provided on said bag body for producing a signal upon actuation;
a power supply circuit coupled electrically to said signal reproduction unit; and
a zipper assembly secured to said bag body and including:
first and second zipper tapes,
a zipper chain having one end and including first teeth secured to said first zipper tape and second teeth secured to said second zipper tape,
a zipper slider mounted slidably on said zipper chain for engaging and disengaging said first and second teeth,
an end stopper secured to said first and second zipper tapes, separated from said zipper chain, disposed adjacent to said end of said zipper chain, and configured to stop further movement and removal of said zipper slider from said zipper chain, and
a switch coupled electrically to said power supply circuit and mounted to said end stopper in such a manner that said switch is switched on by said zipper slider so as to actuate said signal reproduction unit through said power supply circuit when said zipper slider is moved to said end of said zipper chain.

7. The bag of claim 6, wherein said end stopper is formed with a recess, said switch being fitted into said recess.

8. The bag of claim 7, wherein said end stopper is further formed with two openings that are in spatial communication with said recess, said switch having a pair of conductive leads extending through said openings, respectively.

9. The bag of claim 7, wherein said switch is in the form of a pressable button switch and includes a pressable button protruding outwardly of said recess, said pressable button being pressed by said zipper slider when said zipper slider is moved to said end of said zipper chain.

10. The bag of claim 6, wherein said switch is in the form of a contact switch and has a first contact and two second contacts, said first contact being secured to said zipper slider, said second contacts being secured to said end stopper and being spaced apart from each other, said second contacts being connected to each other through said first contact when said zipper slider is moved to said end of said zipper chain.
